(19) United States
(12) Patent Application Publication
(10) Pub. No.: US 2026/0179268 A1
(43) Pub. Date: Jun. 25, 2026

(54) INFORMATION PROCESSING DEVICE AND TRANSFER METHOD

(71) Applicant: Faurecia Clarion Electronics Co., Ltd., Saitama-shi, Saitama (JP)

(72) Inventors: Yuichiro NAKAGAWA, Saitama (JP); Hiroe USHIO, Saitama (JP); Wataru NAKASONE, Saitama (JP)

(73) Assignee: Faurecia Clarion Electronics Co., Ltd., Saitama-shi, Saitama (JP)

(21) Appl. No.: 19/430,943

(22) Filed: Dec. 23, 2025

(30) Foreign Application Priority Data
Dec. 24, 2024 (JP) 2024-227780

(51) Int. Cl. G06T 11/00

(52) U.S. Cl. CPC G06T 11/00

(57) ABSTRACT

To enable image sharing in context and improve usability an information processing device includes a display part that displays a first image and a transfer unit that transfers a second image different from the first image to a display device, and further comprises an address reception unit that receives a prescribed address from an external device, and an image generating unit that generates the second image based on information obtained by connecting to the prescribed address, and the transfer unit sends a notification to the display device asking which of the prescribed address received by the address reception unit and the second image generated by the image generating unit to select, and when the second image generated by the image generating unit is selected, the transfer unit transfers the second image obtained by the image generating unit to the display device.

### TECHNICAL FIELD

The present invention relates to an information processing device and a transfer method.

### CONVENTIONAL TECHNOLOGY

Conventionally, Patent Document 1 is known as a technique for enabling content such as images to be displayable on another device. Patent Document 1 states, “To provide an image transmission system that causes image data to be transmitted by a transmission method suited to the needs of a recipient”, and, “An image transmission system including a server 200 and a plurality of image transmission devices 100A-C, wherein the server 200 receives transmission-method designation information indicating a transmission method for image data 505 addressed to the recipient and designated by the recipient, records the transmission-method designation information in association with the recipient, further receives an update of the transmission-method designation information, rewrites the transmission-method designation information corresponding to the recipient using the updated transmission-method designation information, and the image transmission devices 100A to C receive selection of an identifier of a recipient for image data 505 to be transmitted, acquire the transmission-method designation information and a recipient identifier corresponding thereto from the server 200, and, when the selected recipient identifier matches the recipient identifier corresponding to the acquired transmission-method designation information, cause the image data 505 to be transmitted in accordance with the transmission method indicated by the transmission-method designation information.”

### PRIOR ART DOCUMENTS

### Patent Documents

Patent Document 1: Japanese Unexamined Patent Application 2009-094569

### SUMMARY OF THE INVENTION

### Problem to be Solved by the Invention

Conventional technologies have not taken into consideration the ability of recipients to select an image sharing method according to conditions, causing a usability issue. For example, when an in-vehicle device mounted in a vehicle connects through wireless communication to a server at a store that provides drive-through services to order products, the in-vehicle device may link with a terminal inside the vehicle to consolidate orders from multiple occupants. At this time, a rear monitor, a smartphone, or the like can operate as a terminal inside the vehicle. For example, the rear monitor does not have a browser that can connect to the store's server, but receives an image of an order screen generated by an in-vehicle device and accepts product selection operations by the occupant. On the other hand, smartphones and other devices are equipped with a browser that can connect to the store's server, and products can be selected from the order screen generated by the in-vehicle device, or can be used to connect to the store's server and directly generate an order image to select products.

In this manner, the in-vehicle device is preferably able to flexibly select the method of sharing images, and the like with the in-vehicle terminal depending on whether the in-vehicle terminal is equipped with a browser, the requests of the user of the terminal, and the like.

An object of the present invention is to achieve image sharing in accordance with the conditions and to improve usability.

### Means for Solving the Problem

To achieve the object described above, a typical information processing device of the present invention includes:
a display part that displays a first image;
a transfer unit that transfers a second image different from the first image to a display device;
an address reception unit that receives a prescribed address from an external device; and
an image generating unit that generates the second image based on information acquired by connecting to the prescribed address, wherein
the transfer unit transmits a notification to the display device inquiring whether to select the prescribed address received by the address reception unit or the second image generated by the image generating unit, and when the second image generated by the image generating unit is selected, transfers the second image acquired by the image generating unit to the display device.

### Effect of the Invention

According to the present invention, image sharing based on conditions can be achieved, and usability can be improved.

### BRIEF DESCRIPTION OF THE DRAWINGS

FIG. 1 is an explanatory diagram of image transfer by an in-vehicle device that is an information processing device;

FIG. 2 is a system configuration diagram of the present embodiment;

FIG. 3 is a configuration diagram of an in-vehicle device;

FIG. 4 is a configuration diagram of a mobile terminal;

FIG. 5 is a flowchart describing the processing procedure of the in-vehicle device;

FIG. 6 is a flowchart depicting a detailed procedure for processing an inquiry;

FIG. 7 is specific examples of first notification and second notification; and

FIG. 8 is an explanatory diagram of order processing.

### EMBODIMENTS OF THE INVENTION

Next, an embodiment of the present invention will be described using drawings.

### Embodiment 1

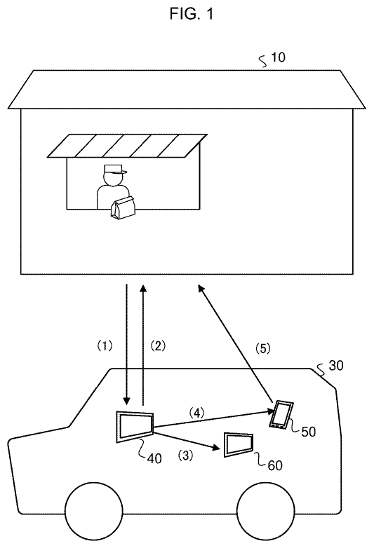

FIG. 1 is an explanatory diagram of image transfer by an in-vehicle device 40 that is an information processing device. The in-vehicle device 40 is an information processing device mounted in a vehicle 30. The in-vehicle device 40 is installed, for example, in the center of the dashboard, between the driver's seat and the passenger seat. The in-vehicle device 40 is provided with a touch panel display that can be viewed from occupants in the driver's seat and the passenger seat. The in-vehicle device 40 can display map information and/or route information. The in-vehicle device 40 also includes a web browser and can connect to the address of an external server via wireless communication. The web browser corresponds to the image generating unit in the claims. The in-vehicle device 40 is capable of communicating with a mobile terminal 50 and a rear monitor 60 in the vehicle, and is capable of transferring images and the like to the mobile terminal 50 and the rear monitor 60.

The mobile terminal 50 is a smartphone terminal, a tablet terminal, or the like carried by the occupant. The mobile terminal 50 has a touch panel display and can receive images and the like transferred from the in-vehicle device 40. The mobile terminal 50 also has a web browser and can connect to the address of an external server via wireless communication.

The rear monitor 60 includes a touch panel display that can be seen by occupants in the rear seats. For example, the rear monitor 60 may be installed on the ceiling of the vehicle cabin, or may be installed on the backrest of the driver's seat and/or of the passenger seat. The rear monitor 60 can receive images and the like transferred from the in-vehicle device 40. If equipped with a web browser, the rear monitor 60 can connect to the address of an external server via wireless communication.

In FIG. 1, the in-vehicle device 40 communicates with a server of a store 10 that provides a drive-through service to place an order. Specifically, the in-vehicle device 40 first receives an address corresponding to an order screen from the server of the store 10 (1). The addresses to receive the email are the address of a main order screen and the address of a sub-order screen.

The main order screen allows you to select products, confirm your order, and execute payment. For convenience, the main order screen is referred to as the first screen or first content. For convenience, the address of the main order screen is referred to as the primary address.

The sub-order screen allows the selection of products. The sub-order screen does not display information regarding order confirmation or payment, and does not have functions for order confirmation or payment. In other words, the sub-order screen has more limited display content and functions than the main order screen. The product selection on the sub-order screen is reflected on the main order screen, and the order is confirmed and payment is executed on the main order screen. The main order screen will consolidate the product selections made on the sub-order screens and act as a representative terminal to confirm and settle the order. For convenience, the sub-order screen is referred to as a second image or second content. For convenience, the address of the sub-order screen is referred to as the second address.

The in-vehicle device 40 accesses the address of the main order screen using a web browser, acquires data used to generate the main order screen, and generates the main order screen. The in-vehicle device 40 displays the generated main order screen on the touch panel display. The in-vehicle device 40 accepts an operation by the occupant to select a product while displaying the main order screen. When the in-vehicle device 40 receives the product selection operation, the in-vehicle device transmits the product selection to the server of the store 10 (2). The main screen will update to reflect product selections.

The in-vehicle device 40 accesses the address of the sub-order screen using a web browser, obtains the data used to generate the sub-order screen, and generates the sub-order screen. The in-vehicle device 40 can transfer the generated sub-order screen to the mobile terminal 50 or the rear monitor 60. The mobile terminal 50 and the rear monitor 60 are display devices that display a sub-order screen. In FIG. 1, the in-vehicle device 40 transfers the sub-order screen to the rear monitor 60 (3). The rear monitor 60 accepts an operation by the occupant to select a product while the sub-order screen is displayed. When the rear monitor 60 receives a product selection operation, the rear monitor transmits the product selection operation to the in-vehicle device 40. The in-vehicle device 40 transmits the product selection operation received by the rear monitor 60 to the server of the store 10. The main screen will update to reflect product selections.

The in-vehicle device 40 can transfer the address of the sub-order screen to the mobile terminal 50 (4). The mobile terminal 50 accesses the address of the sub-order screen using a web browser (5). The mobile terminal 50 acquires data used to generate the sub-order screen from the server of the store 10 and generates the sub-order screen. The mobile terminal 50 accepts an operation from the occupant to select a product while the sub-order screen is displayed. When the mobile terminal 50 receives the product selection operation, the mobile terminal transmits the operation to the server of the store 10. The main screen will update to reflect product selections.

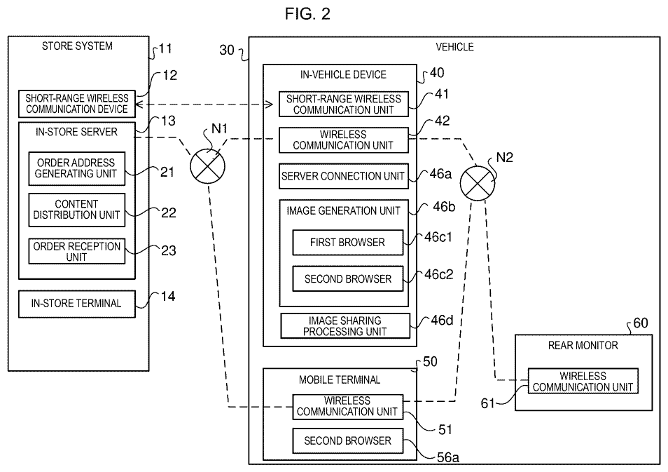

FIG. 2 is a system configuration diagram of the present embodiment. A store system 11 of the store 10 includes a short-range wireless communication device 12, an in-store server 13, and an in-store terminal 14. The store 10 is provided with a wireless communication network N1. The in-store server 13 is capable of communicating with the in-vehicle device 40 and the mobile terminal 50 via a wireless communication network N1.

The short-range wireless communication device 12 performs wireless communication at a shorter distance than the wireless communication network N1. The short-range wireless communication device 12 performs communication using Bluetooth (registered trademark), for example. The short-range wireless communication device 12 periodically transmits a beacon to the surrounding area. The beacon contains information for connecting to the wireless communication network N1.

The in-store server 13 has an order address generating unit 21, a content distribution unit 22, and an order reception unit 23 connected to the wireless communication network N1. The in-store server 13 is, for example, a computer, and the processor executes a program to achieve the functions of the order address generating unit 21, the content distribution unit 22, and the order reception unit 23.

The order address generating unit 21 generates an address of the main order screen and an address of the sub-order screen. When the content distribution unit 22 receives access to the address of the main order screen, the content distribution unit provides data necessary to generate the main order screen, which is the first content. When the content distribution unit 22 receives access to the address of the sub-order screen, the content distribution unit provides data necessary to generate the sub-order screen, which is the second content.

When a product selection operation is performed on the main order screen or the sub-order screen, the order receiving unit 23 adds the product to the order list and updates the main order screen. When a product selection operation is performed on the sub-order screen, the sub-order screen may be updated. The order receiving unit 23 processes the order when a confirmation operation is performed for the order list. The order processing may include outputting product provision instructions via the in-store terminal 14 and payment processing.

The in-store terminal 14 is a terminal used by an employee of the store 10. When the in-store terminal 14 outputs product provision instructions, the employee provides the specified product.

The vehicle 30 is equipped with an in-vehicle device 40 and a rear monitor 60. In addition, a mobile terminal 50 is also present inside the vehicle 30. The vehicle 30 is provided with a wireless communication network N2. The in-vehicle device 40, the mobile terminal 50, and the rear monitor 60 are capable of communicating with each other via the wireless communication network N2.

The in-vehicle device 40 includes a short-range wireless communication unit 41, a wireless communication unit 42, a server connection unit 46a, an image generating unit 46b, and a screen sharing processing unit 46d. The image generating unit 46b further includes a first browser 46c1 and a second browser 46c2. The short-range wireless communication unit 41 performs short-range wireless communication with the short-range wireless communication device 12. Specifically, the short-range wireless communication unit 41 receives a beacon from the short-range wireless communication device 12.

The wireless communication unit 42 is a communication interface that performs wireless communication via the wireless communication network N1 and the wireless communication network N2.

The server connection unit 46a reads information for connecting to the wireless communication network N1 from the beacon received by the short-range wireless communication unit 41. The server connection unit 46a provides the wireless communication unit 42 with information for connecting to the wireless communication network N1, and connects to the wireless communication network N1. In addition, the server connection unit 46a is an address reception unit that accesses the in-store server 13 via the wireless communication network N1 and acquires a main-order-screen address and a sub-order-screen address.

The first browser 46c1 provided in the image generating unit 46b is a web browser that operates as a first image generating unit that accesses the address of the main order screen, obtains data used to generate the main order screen, and generates the main order screen. The first browser 46c1 displays the generated main order screen on a touch panel display 43, which will be described later. The first browser 46c1 accepts an operation by the occupant to select a product while displaying the main order screen. When the first browser 46c1 accepts the product selection operation, the first browser transmits the operation to the in-store server 13.

The second browser 46c2 provided in the image generating unit 46b is a web browser that operates as a second image generating unit that accesses the address of the sub-order screen, obtains data used to generate the sub-order screen, and generates the sub-order screen.

The screen sharing processing unit 46d is a transfer unit that shares the address of the sub-order screen and the sub-order screen with the mobile terminal 50 and the rear monitor 60 via the wireless communication network N2. In addition, the product selection operation on the sub-order screen is transmitted to the in-store server 13.

The screen-sharing processing unit 46d inquires of the mobile terminal 50 or the rear monitor 60 as to which to select between the sub-order-screen address and the sub-order screen generated by a second browser. The screen sharing processing unit 46d transfers the sub-order screen generated by the second browser to the device that has responded to the inquiry by selecting the sub-order screen generated by the second browser. The screen-sharing processing unit 46d transfers the sub-order-screen address to a device that responded to the inquiry by selecting the sub-order-screen address.

The screen sharing processing unit 46d can perform an inquiry with content that corresponds to the configuration of the device. The screen-sharing processing unit 46d sends a notification to a device equipped with a web browser operating as a second browser, inquiring which to select between a sub-order-screen address and a sub-order screen generated by the second browser 46c2. This inquiry is called a first notification. The screen sharing processing unit 46d sends a notification to the device that does not have a web browser that operates as the second browser that the sub-order screen generated by the second browser 46c2 can be provided. This notification is referred to as a second notification. The device equipped with a web browser that operates as the second browser is, for example, a mobile terminal 50. An example of a device that does not have a web browser that operates as a second browser is the rear monitor 60. The configuration of the mobile terminal 50 or the rear monitor 60 may be specified in advance, or may be acquired from the mobile terminal or the rear monitor 60 each time.

The mobile terminal 50 is, for example, a smartphone carried by an occupant. The mobile terminal 50 includes a wireless communication unit 51 and a second browser 56a. The wireless communication unit 51 is a communication interface that performs wireless communication via the wireless communication network N1 and the wireless communication network N2. The second browser 56a is a web browser that accesses the address of the sub-order screen, acquires data used to generate the sub-order screen, and generates the sub-order screen. The second browser 56a displays the generated sub-order screen on a touch panel display 52, which will be described later. The second browser 56a accepts an operation by the occupant to select a product while displaying the sub-order screen. When the second browser 56a accepts the product selection operation, the second browser transmits the product selection operation to the in-store server 13.

The mobile terminal 50 can also receive a sub-order screen generated by the second browser 46c2 from the in-vehicle device 40 and display the sub-order screen on the touch panel display 52 without using the second browser 56a. In this case, when a product selection operation is received, the mobile terminal 50 transmits the product selection operation to the in-vehicle device 40.

The rear monitor 60 includes a wireless communication unit 61 and a touch panel display. The wireless communication unit 61 is a communication interface that performs wireless communication via the wireless communication network N1 and the wireless communication network N2. The rear monitor 60 does not have a second browser and cannot generate a sub-order screen from the address of the sub-order screen.

The rear monitor 60 receives the sub-order screen generated by the second browser 46c2 by the in-vehicle device 40 and displays the sub-order screen on the touch panel display 52. When the rear monitor 60 receives a product selection operation, the rear monitor transmits the product selection operation to the in-vehicle device 40.

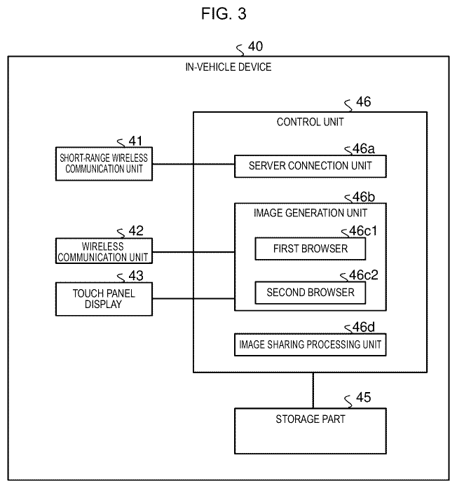

FIG. 3 is a diagram depicting the configuration of the in-vehicle device 40. The in-vehicle device 40 includes a short-range wireless communication unit 41, a wireless communication unit 42, a touch panel display 43, a storage unit 45, and a control unit 46. The touch panel display 43 displays the main order screen and accepts operations such as product selection and order confirmation.

The control unit 46 is, for example, a processor, and by executing a program, achieves the functions of the server connection unit 46a, the image generating unit 46b, the first browser 46c1, the second browser 46c2, and the screen sharing processing unit 46d. The storage unit 45 stores various programs and data.

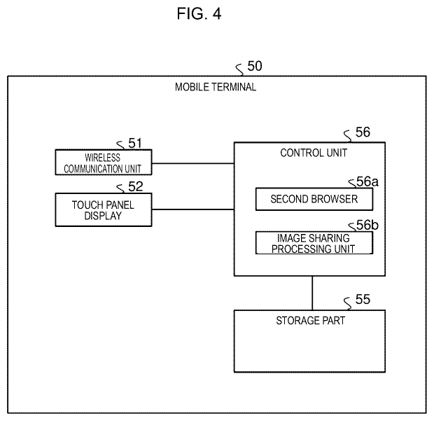

FIG. 4 is a configuration diagram of the mobile terminal 50. The mobile terminal 50 includes a wireless communication unit 51, a touch panel display 52, a storage unit 55, and a control unit 56. The touch panel display 52 displays the sub-order screen and accepts product selection operations.

The control unit 56 is, for example, a processor, and executes a program to achieve the functions of a second browser 56a and a screen sharing processing unit 56d. The screen sharing processing unit 56d receives the address of the sub-order screen, and transmits the sub-order screen and the product selection operation generated by the second browser 46c2. The storage unit 55 stores various programs and data.

The rear monitor 60 differs from the mobile terminal 50 in that the rear monitor does not include a second browser. The other configurations and operations are the same as those of the mobile terminal 50, and therefore illustrations and explanations thereof will be omitted.

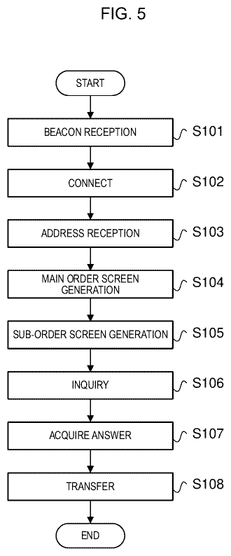

FIG. 5 is a flowchart illustrating the processing procedure of the in-vehicle device 40. The in-vehicle device 40 sequentially executes the following steps S101 to S108.

Step S101: The short-range wireless communication unit 41 receives the beacon and sends the beacon to the control unit 46. Thereafter, the process proceeds to Step S102.

Step S102: The server connection unit 46a reads information for connecting to the wireless communication network N1 from the beacon, and connects to the wireless communication network N1. Thereafter, the process proceeds to Step S103.

Step S103: The server connection unit 46a connects to the in-store server 13 via the wireless communication network N1 and receives the addresses of the main order screen and the sub-order screen. Thereafter, the process proceeds to Step S104.

Step S104: The first browser 46c1 accesses the address of the main order screen and generates the main order screen. Thereafter, the process proceeds to Step S105.

Step S105: The second browser 46c2 accesses the address of the sub-order screen and generates the sub-order screen. Thereafter, the process returns to step S106.

Step S106: The screen sharing processing unit 46d submits an inquiry to the display device that displays the sub-order image. The display device is a device that displays the sub-order screen, and in the present embodiment is the mobile terminal 50 or the rear monitor 60. Thereafter, the process proceeds to Step S107.

Step S107: The screen sharing processing unit 46d acquires responses from the display devices to which the inquiry has been made. Thereafter, the process proceeds to step S108.

Step S108: the screen sharing processing unit 46d transfers either the address of the sub-order screen or the sub-screen generated in step S105 to the display device based on the response from each display device, and then ends the processing.

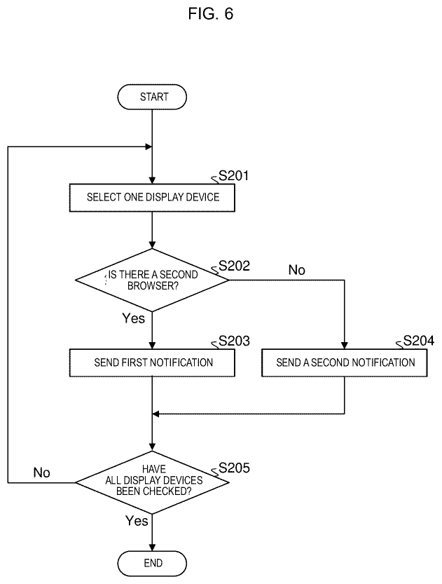

FIG. 6 is a flowchart depicting the detailed procedure of the inquiry process. The inquiry step of step S106 includes the following steps S201 to S205.

Step S201: The screen sharing processing unit 46d selects one display device. Thereafter, the process proceeds to Step S202.

Step S202: The screen sharing processing unit 46d determines whether the selected display device has a second browser. If the selected display device has a second browser (step S202: Yes), the process proceeds to step S203. If the selected display device does not have a second browser (step S202: No), the process proceeds to step S204.

Step S203: The screen sharing processing unit 46d transmits a first notification. The first notification is a notification inquiring whether to select the address of the sub-order screen or the sub-order screen generated by the second browser 46c2. Thereafter, the process proceeds to Step S205.

Step S204: The screen sharing processing unit 46d transmits a second notification. The second notification is a notification that a sub-order screen generated by the second browser 46c2 can be provided. Thereafter, the process proceeds to Step S205.

Step S205: The screen sharing processing unit 46d determines whether or not all the display devices have been selected. If there is an unselected display device (step S205: No), return to step S201. If all display devices have been selected (step S205: Yes), processing ends.

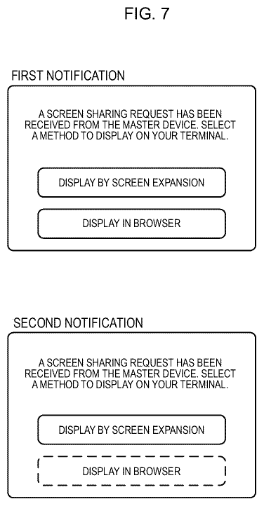

FIG. 7 is a specific example of the first notification and the second notification. The first notification includes a message stating, “A screen-sharing request has been received from the master terminal. Please select a display method for the terminal itself”, a button labeled “Display by screen expansion”, and a button labeled “Display in browser”. The master terminal is a device that displays the main order screen, and in the present embodiment is the vehicle-mounted device 40. “Display on expanded screen” indicates that the sub-order screen is received from the in-vehicle device 40 and displayed. “Display in browser” indicates that a sub-order screen is generated and displayed in the second browser of the device itself. In the first notification, both the “Display by screen expansion” button and the “Display in browser” button are selectable. An operation on either button will be a response to the first notification.

The second notification includes a message stating, “A screen-sharing request has been received from the master terminal. Please select a display method for the terminal itself”, a button labeled “Display by screen expansion”, and a button labeled “Display in browser”. The “Display in browser” button is not selectable. Buttons that cannot be selected may be displayed as grayed out. In the second notification, only the “Display by screen expansion” button can be selected, and operating this button is a response to the second notification.

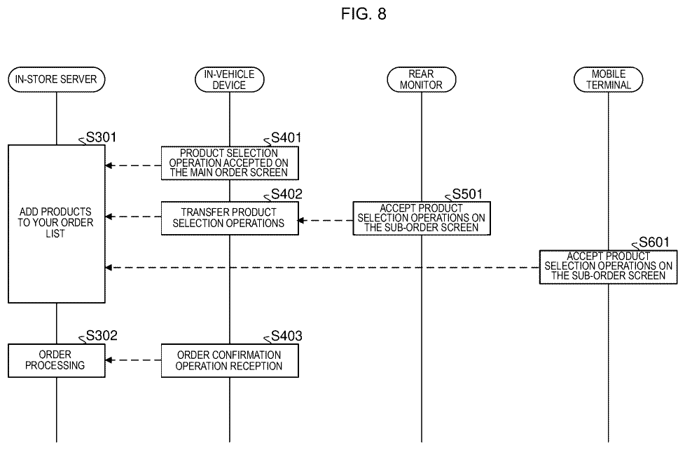

FIG. 8 is an explanatory diagram of order processing. The in-vehicle device 40 accepts a product selection operation on the main order screen and transmits the operation to the in-store server 13 (step S401). The rear monitor 60 accepts a product selection operation on the sub-order screen and transmits the product selection operation to the in-vehicle device 40 (step S501). The in-vehicle device 40 transfers the product selection operation received from the rear monitor 60 to the in-store server 13 (step S402). The mobile terminal 50 accepts the product selection operation on the sub-order screen and transmits the product selection operation to the in-store server 13.

The in-store server 13 adds the product to the order list based on the product selection operation received from the in-vehicle device 40 or the mobile terminal 50, and updates the main order screen (step S301). When the order confirmation operation is received, the in-vehicle device 40 transmits an order confirmation notification to the in-store server 13 (step S403). Upon receiving the order confirmation notification, the in-store server 13 executes order processing (step S302).

As described above, the in-vehicle device 40 is an information processing device that includes a touch panel display 43 as a display part that displays a first image, and a screen sharing processing unit 46d that is a transfer unit that transfers a second image different from the first image to the display device, and further includes a server connection unit 46a as an address receiving unit that receives a prescribed address from an external device, and a second browser 46c2 as an image generating unit that generates the second image based on information obtained by connecting to the prescribed address, and the transfer unit sends a notification to the display device inquiring which of the prescribed address received by the address receiving unit and the second image generated by the image generating unit to select, and when the second image generated by the image generating unit is selected, transfers the second image obtained by the image generating unit to the display device.

With this configuration and operation, the information processing device can achieve image sharing based on the conditions, thereby improving usability.

In addition, the image generating unit includes a first image generating unit and a second image generating unit, the address reception unit receives a first address used to generate the first image and a second address that is the prescribed address used to generate the second image, the first image generating unit generates the first image based on information acquired by connecting to the first address, the second image generating unit generates the second image based on information acquired by connecting to the second address, and the transfer unit transfers the second image generated by the second image generating unit to the display device when the second image is selected, and transfers the second address when the prescribed address is selected.

This configuration and operation enables the display device to select a transfer method suitable for the display device.

In addition, the transfer unit transmits, to a display device connectable to the external device, a notification inquiring which to select between the prescribed address received by the address reception unit and the second image generated by the image generation unit, and transmits, to a display device not connectable to the external device, a notification indicating that the second image generated by the image generation unit can be provided.

With this configuration and operation, the information processing device can provide notifications that are tailored to the configuration of the display device, thereby improving usability.

Moreover, the second image has more limited display content than the first image.

Therefore, appropriate authority management is possible on the display device side and the information processing device side.

Note that the present invention is not limited to the abovementioned examples and includes various modified examples. For example, while the abovementioned examples have been described in detail in order to describe the present invention in an easy-to-understand manner, the present invention is not necessarily limited to those with all the described configurations. Moreover, not only the deletion of such configurations, but also the replacement or addition of configurations is possible.

For example, in the present embodiment, an example of a configuration including one mobile terminal 50 and one rear monitor 60 has been described, but there may be a plurality of mobile terminals 50 and a plurality of rear monitors 60. Furthermore, either the mobile terminal 50 or the rear monitor 60 may be omitted.

### DESCRIPTION OF REFERENCE NUMERALS

10. Store, 11. Store system, 12. Short-range wireless communication device, 13. In-store server, 14. In-store terminal, 21. Order address generating unit, 22. Content distribution unit, 23. Order reception unit, 30. Vehicle, 40. In-vehicle device, 41. Short-range wireless communication unit, 42. Wireless communication unit, 43. Touch panel display, 45. Storage unit, 46. Control unit, 46a. Server connection unit, 46b. Image generating unit, 46c1. First browser, 46c2. Second browser, 46d. Screen sharing processing unit, 50. Mobile terminal, 51. Wireless communication unit, 52. Touch panel display, 55. Storage unit, 56. Control unit, 56a. Second browser, 56d. Screen sharing processing unit, 60. Rear monitor, 61. Wireless communication unit.

1. An information processing device comprising:
a display part that displays a first image;
a transfer unit that transfers a second image different from the first image to a display device;
an address reception unit that receives a prescribed address from an external device; and
an image generating unit that generates the second image based on information acquired by connecting to the prescribed address, wherein
the transfer unit transmits a notification to the display device inquiring whether to select the prescribed address received by the address reception unit or the second image generated by the image generating unit, and when the second image generated by the image generating unit is selected, transfers the second image acquired by the image generating unit to the display device.

2. The information processing device according to claim 1, wherein
the image generating unit includes a first image generating unit and a second image generating unit,
the address reception unit receives a first address used to generate the first image and a second address that is the prescribed address used to generate the second image,
the first image generating unit generates the first image based on information acquired by connecting to the first address,
the second image generating unit generates the second image based on information acquired by connecting to the second address, and
the transfer unit transfers the second image generated by the second image generating unit to the display device when the second image is selected, and transfers the second address when the prescribed address is selected.

3. The information processing device according to claim 1, wherein the transfer unit transmits, to a display device connectable to the external device, a notification inquiring which to select between the prescribed address received by the address reception unit and the second image generated by the image generation unit, and transmits, to a display device not connectable to the external device, a notification indicating that the second image generated by the image generation unit can be provided.

4. The information processing device according to claim 1, wherein the second image has display content that is restricted in comparison to the first image.

5. A transfer method for transferring, to a display device that communicates with an information processing device, a second image different from a first image displayed on a display unit of the information processing device, the method comprising:
a reception step of the information processing device receiving a prescribed address from an external device;
an image-generation step of generating the second image based on information acquired by connecting to the prescribed address;
an inquiry step of placing an inquiry, to the display device, which to select between the prescribed address received in the reception step and the second image generated in the image-generation step;
an answer-acquisition step of acquiring, from the display device, an answer to the inquiry; and
a transfer step of transferring the second image generated in the image-generation step to the display device when the second image generated in the image-generation step is selected in the answer-acquisition step.

6. The transfer method according to claim 5, wherein the image-generation step includes a first image-generation step and a second image-generation step, the reception step receives a first address used to generate the first image and a second address that is the prescribed address used to generate the second image, the first image-generation step generates the first image based on information acquired by connecting to the first address, the second image-generation step generates the second image based on information acquired by connecting to the second address, and the transfer step transfers the second image generated in the second image-generation step to the display device when the second image is selected, and transfers the second address when the prescribed address is selected.

7. The transfer method according to claim 5, wherein the transfer step transmits, to a display device connectable to the external device, a notification inquiring which to select between the prescribed address received in the reception step and the second image generated in the image-generation step, and transmits, to a display device not connectable to the external device, a notification indicating that the second image generated in the image-generation step can be provided.

8. The transfer method according to claim 5, wherein the image-generation step generates the second image whose display content is restricted in comparison to the first image.
